(19) United States
(12) Patent Application Publication
(10) Pub. No.: US 2020/0348729 A1
(43) Pub. Date: Nov. 5, 2020

(54) Handheld Folding Electronic Device

(71) Applicant: Wei Hu Koh, Irvine, CA (US)

(72) Inventor: Wei Hu Koh, Irvine, CA (US)

(73) Assignee: Wei Hu Koh, Irvine, CA (US)

(21) Appl. No.: 16/403,422

(22) Filed: May 3, 2019

(51) Int. Cl. G06F 1/16; G06F 3/041; H04M 1/02

(52) U.S. Cl. CPC G06F 1/1656; G06F 1/1626; H04N 5/2257; H04M 1/0214; G06F 2203/04102; G06F 3/041

(57) ABSTRACT

A handheld electronic device comprises of a lower slat having a top surface touchscreen and an upper slat having a top surface touchscreen. A plurality of multiple-foldable sectional touchscreens in between the said slats has one end connected to the upper slat surface touchscreen and the other end connected to the lower slat surface touchscreen. A fan-out embodiment has a plurality of tapered sectional screens each supported by a rib, and a pivoting rivet linking upper and lower slats for fan-out opening. A pull-out embodiment has rectangular sectional screens supported by stiffening backing and expandable side frame supports for opening and closing the device slats. Another pull-out device embodiment has no foldable screens in between slats to form a two-screen, parallel slat device when opened.

This application claims the benefit of provisional patent application No. 62/732,293, filed Sep. 17, 2018, which is incorporated hereby by reference herein in its entirety.

### BACKGROUND OF THE INVENTION

### 1. Field of the Invention

This relates generally to handheld mobile electronic devices such as smartphones and tablets having touchscreen displays for operation and information display.

### 2. Description of the Related Art

Typical handheld smartphones and tablets have planar and flat display touchscreens with a rigid protecting cover. When the display screen sizes become larger, the size of the device becomes correspondingly bigger as well. However, large-sized devices can be more cumbersome to hold in one hand and to be carried inside small pockets and handbags.

In attempts to show increased display area while not occupying too much planar space, foldable devices have been designed for handheld electronic devices with flexible or bendable display screens. Several different types exist. One is devices that can be bent along an axis in the body to form a two-sided, U-shaped device having a curved edge. Another one uses devises having a straight folding line along a seam line or hinge such that the device is folded like a wallet or a clamshell (U.S. Pat. No. 9,485,862 by Apple Inc.). Some devices may even have two or more seam lines and be folded multiple times. After folding, the device footprint area is reduced but its thickness typically becomes more than doubled.

Yet a third type of folding display uses moving rollers to retract and store a rolled screen. The retracted screen may be stored either in a single housing or two separate cylinder-shaped housing (US 2017/0060183 A1). This type of rolling scroll design may need moving parts and requires a large internal space to store the rolled display screen.

There is therefore a need for a more compact device that allows expanded display screen size when needed while still be easily held by one hand. When not in use, the device may be folded to shrink its footprint area for ease of handling and carrying. Further, after bending or folding, the device body thickness would not increase to become twice as thick. While in the retracted or folded state, the device remains functional as a smaller smartphone and camera.

### SUMMARY OF THE INVENTION

A smartphone or tablet device comprises of two slim, slat-like compartments linked by a multiple foldable touchscreen in between. The upper daughter slat is slightly smaller than the lower mother slat so that it can be tucked-in securely above the lower slat. Each of the two slats has a top surface touchscreen connected to the folded middle screen. The middle touchscreen screen is a continuous, flexible, foldable fabric-like then sheet material having a plurality of bending seam lines that permit folding without visible creases. For devices having a fan-out embodiment, the middle screen is fan-shaped and divided into a plurality of narrower, tapered sectional screens that are each supported by a rib on backside. A pivoting rivet links the upper and lower slats together on the lower end and allows fan-out rotation for opening the folded middle screen. The middle, alternatively, can be a plurality of rigid or semi-rigid sectional screens linked together with foldable bending seams.

A second two-slat device embodiment comprises of similar upper slat, lower slat, and a connected folded touchscreen in the middle. The middle screen comprises of a plurality of narrower rectangular sectional screens that can be pulled out to form a large, rectangular display screen. Instead of a pivoting rivet, two extendable guide pins are used for expansion and contraction of the slats and the middle screen. The backside of each middle sectional screens may be supported by stiffening backings for better flatness and rigidity; the two extendable guide pins further serve as device body frame support in open position.

The touchscreen materials for both embodiments can be flexible OLED (organic light-emitting diode), AMOLED (active matrix OLED), LCD, e-ink paper, or touch-sensitive display based on micro-LED. The touchscreen front-side has necessary protection layers or flexible, bendable thin glass with touch-sensitive functions. Semi-rigid thin ribs or foils may be attached to the backside of each sectional screen to keep the screen flat and dimensionally stable.

The slat housing materials can be thin metals, engineered plastics, epoxy composite materials, glass, ceramics, or laminates of natural materials such as wood or bamboo. Additives such as graphene, carbon nanotubes or other nanoparticles may be added to enhance the housing mechanical and thermal properties.

For both device embodiments, a camera module is preferably attached to the lower mother slat housing, with the camera module height equal to the closed device body height. This way, high quality CMOS digital camera sensors and a variety of multiple lens systems, including telephoto lenses, wide-angle lenses, and ultra-wide-angle lenses, may be placed inside the camera module housing. The camera module further can be made rotatable to face the front and the backside of the device, using the same camera for both front-side selfie and back-side photo/video taking.

In the fan-out device embodiment, a pivoting rivet connecting the two slats is used as the rotating axis for fan-out and fan-in of the upper slat. Each of the middle sectional touchscreen is tapered so that the opened screen forms a continuous, fan-shaped large screen that is connected to the top surface screens of the upper and lower slat, respectively. The device may therefore be opened and closed like a hand-held Chinese silk fan. The thin ribs supporting each sectional screen are connected to the pivoting rivet to support the rotation motions for fan-out and fan-in, while also stabilizing the flatness and improving the rigidity of the middle sectional screens.

The pivoting rivet can be either a simple mechanical rotating cylinder with built-in clips or springs to control the fan-out angle, or, it can be an electromechanical device powered by one or more micro-motors that drives the rotation motion automatically with the push of a control button. The device fan-out direction is typically clockwise, but if needed, counter-clockwise fan-out rotation may be made.

The device fan-out angle is preferably preset to 90 degrees, 120 degrees, or 150 degrees, depending on the width and number of folds of the middle sectional screens. Because one end of the middle screen connects to the top surface screen of the upper slat and the other end of the middle screen connects to the top surface screen of the lower slat, a full spread-out screen will have a gradual tilt between the two slats. When the device is held by hand, the tilted screen angle may easily be adjusted to be perpendicular towards the viewing direction.

To seat the upper daughter slat and the middle screen securely when retracted, the lower mother slat may have elevated edge guards on three sides to protect and seal the folded middle screen. Hence, the upper slat dimensions should be slightly smaller and thinner to be more easily cradled by the lower slat. The retracted device can thus be handled and carried easily in smaller pockets and bags.

While in the closed position, the upper slat surface touchscreen is exposed and remains functional. The closed device continues to perform as a small smartphone device, suitable for selfie when the camera is facing the front, and picture/video taking when the camera is facing the backside.

In the pull-out device embodiment, the upper slat sits on the lower slat in a closed position but is not linked to the lower slat by a rivet. It is pulled out to open in a sideway, parallel motion along two extendable or telescoping sliding guides. The middle screen is comprised of a plurality of narrow rectangular sectional screens linked by foldable seam lines. One end sectional screen is connected to the surface screen of the upper slat and the other end sectional screen is connected to the surface screen of the lower slat. The fully opened screen forms a large, continuous rectangular screen.

To keep the upper slat in open, immobile position and the middle screens fully stretched and flat when the device is opened, a body frame support and locking mechanism is needed. Three mechanical schemes are disclosed, those skilled in the art may employ other suitable methods to stability the opened slats in a sturdy, fixed position. In the first scheme, a pair of thin miniature telescoping tubing is used as the device body frame-supporting stiffener along the upper edge and the lower edge of the open screen. A second scheme is adding thin stiffening backings, such as thin foils or wire mesh, to each middle sectional touchscreen to stiffen and stabilize the large open screen. The third scheme is applying linked but foldable stiffening back-side strips across the middle sectional screens, using micro hinges at each bending seam line to keep the opened large middle screen flat and stable. A pull-out device may use combination of the screen backings and side frame supports to stabilize the opened device.

One additional two-slat, pull-out embodiment is a device without any middle folding screens. When closed, the upper slat sits on top of the lower slat, each slat having its own top surface touchscreen. When pulled apart, the upper slat slides out to be in a side-by-side, parallel position with the lower slat, forming a planar, thinner device with its touchscreen area doubled. Suitable mechanical means such as internal coil spring tensioners may be used to hold the two slats together in either stacked or parallel position.

With two separate slat compartments, internal components may be distributed optimally inside each slat compartment. One option is placing a majority of components and power supply battery pack inside the thicker lower slat while keeping the upper slat compartment thin; another option is keeping most electronic components inside the upper slat while placing the battery pack and power supply/management system inside the lower slat to allow for more room for higher capacity batteries and easy battery exchange or replacement.

Another device embodiment applicable to both the fan-out and pull-out device embodiments is adding a bendable edge shield and an auxiliary side strip touchscreen to the outer edge side of the upper slat. When bent down by 90-degrees, this side strip screen acts as an edge guard for a device in closed position. When flipped to horizontal position, this strip screen extends further the frontal display screen area when a device is used in the closed position as a small smartphone.

As a compact hand-held electronic device in closed position, the device dimension resembles a folding hand-held fan or a Swiss Army pocket knife; can be easily placed inside a small pocket or handbag. The preferred overall device body width is about 15 to 30 mm. body length 100 to 180 mm, and a body thickness no more than 20 mm.

### BRIEF DESCRIPTION OF THE DRAWINGS

FIG. 1 is a perspective view of a fan-out device in retracted position, with top slat and folded screen sitting on top of lower slat. Camera module attached to the lower slat has lenses facing up.

FIG. 2 is a top view of a fan-out device in retracted position, with top slat and its surface touchscreen facing up. A camera module with lenses facing up is attached to the lower slat.

FIG. 3 is a cross-sectional view of a fan-out device having a pivoting rivet linking the upper slat and lower slat, a multiple-folded touchscreen tucked-in between upper and lower slats, and an edge shield on each side.

FIG. 4 is a perspective view of a stand-alone top slat having a touchscreen on top surface and a bent-down side screen and edge shield.

FIG. 5 is a perspective view illustrating a fan-out device bottom slat assembly having an edge shield protecting the folded middle touchscreen and a pivoting rivet at the lower end.

FIG. 6 illustrates a top view of a fan-shaped foldable screen in fan-out position; thin ribs supporting tapered sectional screens are connected to the pivoting rivet.

FIG. 7 illustrates a 90-degree fan-out device deploying three different active display areas across the open touchscreen.

FIG. 8 illustrates a 120-degree fan-out device having a plurality of tapered sectional screens linked by foldable seam lines and a single, rectangular active display in landscape mode across the screen.

FIG. 9 is a perspective view of another fan-out device having a right-hand side link between top surface screen and multiple-foldable sectional screens.

FIG. 10 illustrates a perspective view of a pull-out device having a plurality of rectangular folded middle screens in between upper and lower slats.

FIG. 11 is a top view of a pull-out device having an open rectangular screen and a pair of telescoping tubing as device body frame stiffeners.

FIG. 12 illustrates a pull-out device having open rectangular middle screens supported by stiffening backing foils linked by foldable hinges along each screen folding seam line.

FIG. 13 illustrates a pull-out device having open rectangular middle screens supported on backside foldable stiffening strips forming an X-frame across the open screen.

FIG. 14 is a perspective view illustrating a pull-out device having no middle folding screens; its upper slat is pulled aside next to lower slat to form a two-screen open device.

### DETAILED DESCRIPTION

Two different embodiments for the two-slat smartphone devices are disclosed. The first one is a fan-out embodiment and the second, a pull-out embodiment. Each embodiment is described in details below.

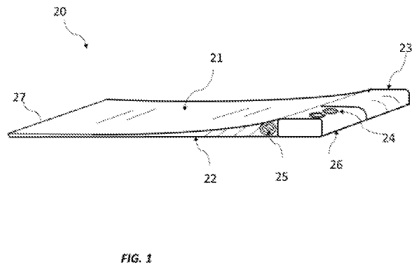

In FIG. 1, a fan-out device 20 resembling a slab-like folded pocket Swiss Army Knife is shown. The device 20 comprises of an upper daughter slat compartment 21, a lower mother slat compartment 22, a group of multiple-folded flexible touchscreen 25 sandwiched in-between, and a camera module 26 attached to the top end of lower slat 22. A pivoting rivet 51 links the two slats together at the bottom end. A control button 23 on top of rivet 51 can be used as a switch to fan-out the upper slat 21, while also function as a home-button for device 20. The lower slat 22 has a raised edge shield 19 on the back side to secure and protect both upper slat 21 and folded screen 25 beneath while in the tucked-in position. When device 20 is in open fan-out position, upper slat 21 is rotated by 90-degrees or greater around the pivoting rivet 51, pulling open the multiple-folded sectional screens 25. Each of the folded sectional screens 25 is supported by a thin rib 52 connected to the rivet 51. When device 20 is in open position, the raised edge shield 19 can be depressed downwards or flipped sideways to become flush with touchscreen 39 on the top surface of lower slat 22. Touchscreen 24 on the top surface of upper slat 21 is connected to the top folded sectional screen in 25. A camera module 26 having front-facing lenses 27 is attached to the lower slat 22. By rotating or flipping the camera module 26, the front lenses 27 can be turned to face the device 20 backside. Control buttons may be placed on sidewalls and end walls of lower slat 22 and camera module housing 26. Button 37 on the sidewall of lower slat 22, and button 36 on the camera module 26 sidewall are examples illustrating various possible locations for device opening ports and control switches.

The top end section 29 and lower end section 17 of upper slat 21 is rounded and curved to allow for clearance and smooth rotation in and out from the lower slat 22.

For better illustration, in FIG. 1 the right-hand side edge shield is removed to expose the folded screens 25. To be shown in subsequent figures, a right-hand side flipping shield having a screen extension on top surface it attached to upper slat 21 and can be bent down to seal device 20 in closed position.

Device 20 remains functional in closed position shown in FIG. 1 as a small smartphone, using surface touchscreen 24 for touch control and input. Camera 26 selfie mode is possible with lenses 27 facing the front, and for picture/video taking with lenses 27 turned to face device backside. If the camera module 26 is not flappable or rotatable, two or more camera systems may be placed inside the camera module housing 26 with separate lens systems 27 facing both the front and back.

FIG. 2 is the top view of a closed fan-out device 20 in a vertical position. Camera module 26 is attached to the top end of lower slat 22, with two lenses 27 and a flash window 38 illustrated. Upper slat 21 sits above the lower slat 22 against side edge shield 19. the top end section 29 and lower end section 31 of upper slat 21 are curved for clearance and ease of sliding in and out of lower slat 22. Button 23 on the top surface of slat 21 may be used as a home button and a switch for fan-out of the upper slat 21. Top surface screen 24 on the top surface of upper slat 21 extends over the right-hand side edge and wraps downwards to connect with a side strip screen resting on side shield 28. The left-hand side edge of the screen 24 wraps downward around the left edge of slat 21 to connect to the first sectional screen in 25 beneath slat 21 and above slat 22.

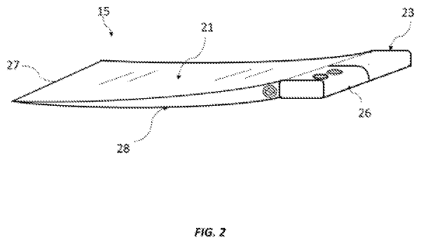

FIG. 3 is a cross-sectional view of fan-out device 20 having a pivoting rivet 51 linking upper slat 21 and lower slat 22. Button 23 sitting on top of rivet 51 may be used as a switch for fan-out rotation and also a home button for device 20. Pivoting rivet 51 can be a cylinder having groves or spring clips to lock-in the fan-out rotation to a preset angle. Or, rivet 51 can be a miniature electromechanical component having one or more micromotors to power drive the fan-out rotation of upper slat 21. Control button 23 can be the power switch for fan-in and fan-out rotations.

The folded middle screens 25 are stored in between upper slat 21 and lower slat 22. The upper-most folded sectional screen 25a connects to the top surface screen 24 by wrapping around the left-hand side edge of upper slat 21. The lower end sectional screen 25g connects to the surface screen 39 on slat 22 by bending around the right-hand side. Hence, the number of folded middle sectional screens is preferably in odd numbers such as 3, 5, 7, or 9. To better illustrate the fixed surface screens 24 on slat 21, 39 on slat 22, and 52 on side shield 28, their thicknesses are intentionally exaggerated in FIG. 3. Side shield 28 and screen 52 is shown bending down in device 20 closed position to seal the right-hand side. While operating closed device 20, however, side shield 28 may be flipped up to be flat along the edge of upper slat 21, and side screen 52 becomes an extension of top surface screen 24 for more viewing area.

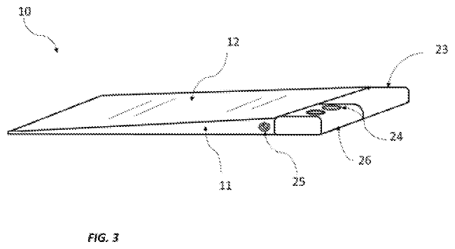

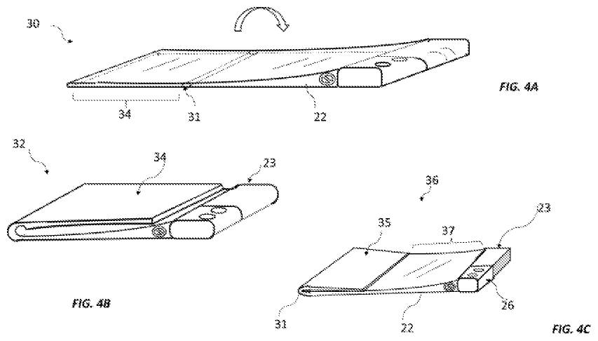

FIG. 4 illustrates a stand-alone top slat compartment 21. The top surface touchscreen 24 wraps around slat 21 left-hand edge 30 to connect to a foldable sectional screen beneath. The right-hand side edge of surface screen 24 is curved to connect to an auxiliary strip screen 52 on top surface of edge shield 28. When shield 28 and screen 52 is flipped to be flat with surface screen 24, screen 52 serves to further extend the service area of top screen 24. When bent down, shield 28 and screen 52 serve as side edge shield for device in closed position.

Through-hole 33 located at the lower curved end 31 of upper slat 21 is for accommodating a pivoting rivet for the fan-out device. The top end section 29 of slat 21 is rounded to provide clearance for sliding motions in and out from the lower slat.

FIG. 5 illustrates a lower slat assembly 39 for fan-out device embodiment. A pivoting rivet 51 is at the lower section of slat 22, and a camera module 26 is attached to the top end of slat 22. Rivet 51 is anchored to slat 22 housing and may contain internal grooves and spring-loaded pins to lock in the fan-out rotation angle. Rivet 51 may optionally be motor-driven for power fan-in and fan-out rotations. Tapered multiple-folded middle sectional touchscreens 25 sit above surface screen 39 on top surface of bottom slat 22 when tucked-in. The top sectional screen of screen 25 is connected to the surface screen of the upper slat (not shown) so that when the upper slat is rotated to fan-out position, the folded screen 25 is pulled out and spread open to form a large semicircular fan-shaped flat screen. Each folded sectional screen 25 is tapered to shape like a long, narrow trapezoid. Elevated edge shield 19 on slat 22 is shown for protection of device left-hand side.

In FIG. 5, the camera module 26 height is preferably flush with the edge shield 19, or the body height of closed device. However, camera module 26 height can differ from the folded device body height to provide optimum depth and space for sophisticated telephoto/wide angle lens systems 27 and camera sensors to be placed inside the camera module 26 to achieve higher photographic performance and better quality. Further, the shape and size of camera module housing 26 can vary in different form factors such as rectangular, square, cylindrical, or hemispherical. Camera module housing 26 is mechanically and electrically connected to the body of the lower slat 22 such that rotating sideways or flipping to have the camera lenses 27 facing different sides and angles is possible. During picture-taking with the device in tuck-in position, the front display on the top slat (24 in FIG. 1) shows the photo images as viewed by the camera lenses. Camera module 26 also works when the device in in the fully opened position, similar to taking a photo using a tablet with a large screen. A control button 36 is shown on the sidewall of camera module housing 26, and another switch control 38 is shown on the sidewall of slat 22.

A fan-shaped screen 25 with 90-degree fan-out angle is depicted in FIG. 6. The backside of the foldable touchscreen 25 may include thin flex routing circuits containing signal traces and power lines for communication and power supply between upper slat and lower slat components. Each sectional screen 25a, 25b, 25c, 25d, and 25e backside is supported by ribs 35a, 35b, 35c, 35d, and 35e, respectively. Each rib extends from the narrow side of each sectional screen and links to pivoting rivet 51 to stabilize screen flatness while facilitate rotation during fan-in and fan-out. Touchscreen 39 is connected to sectional screen 25e with a folding seam line 36f. Screen 25e is connected to next sectional screen 25d by folding seam line 36e, and so on till sectional screen 25a is connected to screen 24 by folding seam line 36a. Although in FIG. 6 five sectional screens 25a, 25b, 25c, 25d, and 25e are shown, the exact number of folded middle sectional screens may vary, preferably in odd numbers between three and nine, depending on the width of each sectional screen and the number of screens needed to reach the preset device fan-out angle. Regardless of the preset fan-out angles, the number of middle sectional touchscreens is preferably with odd numbers 3, 5, 7, and 9, etc., the reason being that the first sectional screen 25a is connected to the left-hand side of screen 24 on upper slat, and the last sectional screen 25e is connected to the right-hand side of screen 39 on lower slat, as better illustrated by FIG. 3 showing the cross-sectional view of a folded screen.

For devices having other preset fan-out angles such as 120-degree or 150-degree, the number of sectional screens required will vary accordingly. The gap height between the top and the bottom slats is also adjusted accordingly to accommodate the folded middle screens.

The maximum width of each individual sectional screen is limited by the slat body width. In FIG. 6, the width of each sectional screens 25a, 25b, 25c, 25d, and 25e is slightly less than the width of the top slat to be tucked-in completely. When large screen 25 is folded, only the top screen 24 is visible on device surface for touch-control functions.

The multiple foldable screen 25 may comprise of one single, continuous, fabric-like flexible screen having pre-defined folding seam lines to form a plurality of foldable sectional screens. Alternatively, screen 25 may comprise of a plurality of rigid or semi-rigid sectional screens linked together by folding seam lines having minimal creases when opened. The back of each sectional screen is supported by a thin rib linked to the rotating rivet 51.

In FIG. 7, a 90-degree fan-out device 45 is shown. Lower slat 22 and upper slat 21 are locked in position at a 90-degree angle by control button 23. Although the entire open touchscreen 25 is capable for display, for more conventional viewing habits, one large, single rectangular viewing area (not shown) or several smaller display areas 42, 43 and 44 across screen 25 may be formed by internal operating software. For example, display area 42 may show time, temperature and calendar information; display area 43 the web content or working document; and display area 44, a virtual keypad. Other unused screen areas may show background screen wallpaper or turned dark. Camera module 26 attached to lower slat 22 may be activated and show images seen by the lenses in the large display area 43.

The housing materials for slat 21 and 22 may be engineering plastic, metals (aluminum, stainless steel, titanium, magnesium, etc.), glass, ceramic, epoxy composites, wood laminates, or even biodegradable, engineered renewable natural materials such as bamboo, cellulose fibers, or paper. Additives such as nanocarbon tubes, graphene, and other nanoparticles may be applied to the composite and laminate housing materials to enhance thermal and mechanical properties and performance. Use of stiff thin-walled materials allows device slats 21 and 22 to remain thin and strong.

Typically, the thicknesses of lower slat 22 and upper slat 21 are less than 10 mm. The gap space in between the upper and lower slat, that is, the slot opening space available for storing the multiple-folded screen 25, is optimized based on the total height of the folded middle screen that is typically less than 10 mm. The overall body thickness of the closed device 45 is preferably less than 20 mm; the overall device length (including camera module 26) less than 180 mm; and the device body width, less than 30 mm. These preferred device dimensions also apply to the pull-out embodiment.

In FIG. 8, a device 46 having a 120-degree fan-out opening is shown. A rectangular active display area 41 in landscape mode is shown across the fan-shaped open screen 25. A portrait mode active display area may also be selected (not shown) when desired. Alternatively, various dynamic active display areas may be selected by the user across the large open screen 25. The pivoting rivet button 23 locks the upper slat 21 and the lower slat 22 in place to keep screen 25 fully stretched and flat. Seven folding seam lines 44a, 44b, 44c, 44d, 44e, 44f, and 44g separating the tapered individual sectional screens are shown as an example. The exact number of folding sectional screens is dependent on the upper slat 21 width and the number of folds needed to reach the 120-degree opening angle. Behind each sectional screen on the backside are narrow ribs (not shown) connected to pivoting rivet underneath button 23 to aid fan-in and fan-out motions.

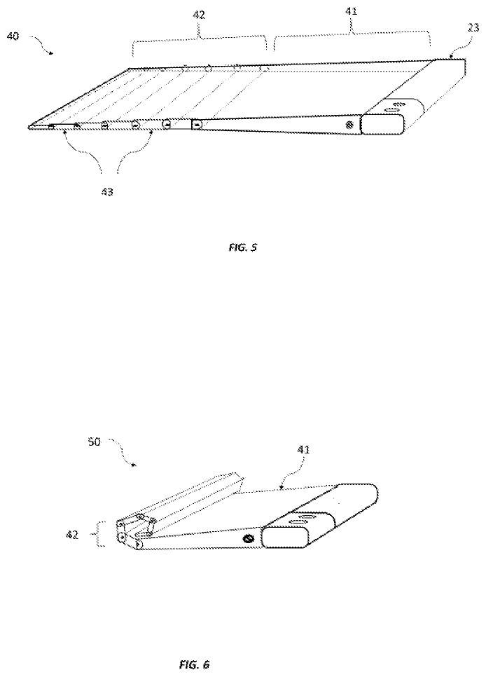

FIG. 9 is a perspective view of another fan-out device 10 having a top surface screen 24 on upper slat 21 and surface screen 39 on lower slat 22, each connected to the multiple-foldable middle screen 50. However, different from FIG. 3, the link between screen 24 and first sectional screen of middle screen 50 is on the right-hand side of screen 24; and link between last sectional screen of middle screen 50 to surface screen 39 on lower slat 22 is on the left-hand side. Camera module 26 is attached to lower slat 22. No edge shields on upper slat 21 and lower slat 22 are shown. The purpose of FIG. 9 is to illustrate that connection from the top surface screen to middle sectional screen can be made either on the right-hand side as in FIG. 9, or the left-hand side as in FIG. 2 and FIG. 3. The fan-out rotation may be either clockwise or counterclockwise, depending on which edge of the lower slat 22 has a side shield that prevents rotation movement in that direction.

A two slat pull-out device 40 is shown by FIG. 10 in a perspective view, right-hand side shield attached to upper slat 21 removed to expose internal device structure and configuration for illustration purpose. On the top surface of upper slat 21 is touchscreen 24, connected on its left-hand side to folded sectional screens 50 beneath. Device 40 left-hand side is protected by side shield 19 from lower slat 22. When slat 21 is pulled away from slat 22 to open device 40, side shield 19 may remain in upright position, or optionally, be depressed to become flat and on the same level as lower surface screen 39 on lower slat 22. Each sectional screen of folded screen 50 is in rectangular shape and not tapered, so that the opened large screen 50 remains rectangular in shape.

Two mechanical links 53 and 55 are installed in between upper slat 21 and lower slat 22 as a means to hold the slats together. For example, mechanical links 53 and 55 are expandable telescoping tubing that may be stretched when pulled out and contracted when pushed in, in a parallel direction, to allow opening and closure of device 40. A camera module 26 is attached to lower slat 22. Module 26 is rotatable to allow camera lens window 27 to face either device front or backside.

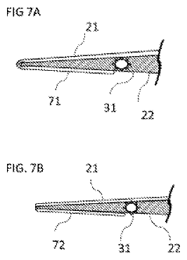

In FIG. 11, the top view of a pull-out device 40 in open position is shown, with lower slat 22 on the left-hand side and upper slat 21 on the right-hand side. The middle multiple-foldable screen 50 comprises of a plurality of rectangular sectional screens connected together with foldable seam lines 36 in between each sectional screen. When center screen 50 is pushed back in, the sectional screens fold and stack up to fit between lower slat 22 and upper slat 21. The lower slat 22 has an elevated edge shield 19 on the outside to help cradle and secure the upper slat 21 and the folded middle screen 50. In the open position, surface touchscreen 39 of the lower slat 22 is exposed and forms a part of the large open screen 50. When closed, screen 39 hides underneath screen 50 and becomes invisible. Touchscreen 24 on the top surface of upper slat 21 remains on top in the closed position and functions as the active touchscreen of the closed device 40. The bendable side screen 52 on side shield (not shown) is flipped instead of bending down to add increased screen area of screen 24. For better handing or gripping device 40, keeping the side shield and side screen 52 folding down is suggested, since there is little need to increase the viewing area of screen 24.

The front side of each sectional screen as part of large screen 50 is covered with protection layers having touch-sensitive capability for touch control. In FIG. 11, no backside support for middle screen 50 is shown. Without any support, the foldable middle screen 50 could be wobbly and unstable. A structural support is needed to keep slats 21 and 22 in open, fixed position and the middle screen 50 flat and sturdy. Those skilled in the art may employ various structural support mechanisms to hold the two separated slats 21 and 22 in place. One example shown in FIG. 11 is a pair of miniature telescoping tubing 53 and 55, stored inside hallow housing 54 and 57, respectively when device 40 is closed. When device 40 is pulled open, tubing 53 and 55 extend fully to lock in the position of slat 21 and 22 while keeping open screen 50 flat and sturdy. The expandable hollow tubing 53 and 55 can be bistable metals or composites connected to the slats on both ends. Power supply and electrical communication between the two slats can be made through flexible circuits attached to the back of middle screen 50. Alternatively, connection cables and power lines may be placed inside the hollow tubing 53 and 55 for communications between slat 21 and 22. The end screen 24 to top surface of slat 21 extends over an attached side shield that bends down when device 40 is closed, but may be flipped open to be flat with screen 24 and become an extension of screen 24.

FIG. 12 shows another optional open device 56 body frame support mechanism, wherein each of the foldable sectional screens in middle screen 50 has a stiffening support foil 58 on the back. Each support 58 has a plurality of foldable micro hinges 59 along the bending seam lines to stiffen the open screen 50 and the two separated slats 21 and 22 of device 56. Side screen 52 is curved and bent downwards with a side shield.

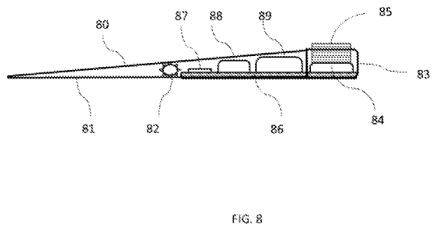

Yet another screen supporting scheme is given in FIG. 13, wherein the device 56 middle screen 50 backside is supported by linked thin stiffening foil strips 63. Each of the foil strips 63 is foldable at the connecting seam lines between each sectional screen. These backing strips 63 are placed diagonally across the center of screen 50 and along the side edges 64, providing further structural strength reinforcement to the open device 56. Again, side screen 52 is curved and bent down as a side shield along the right-hand side of screen 24.

The said screen strengthening backings described in FIG. 12 and FIG. 13 may be combined with the side frame supports described in FIG. 11 to form a more robust structure and sturdy open devices 40 and 56 during hand-held operations. The right-hand side shield 28 shown in FIG. 3 is attached to slat 21 for the pull-out device 40 and 56, and can be bend down to shield the device edge, or be flipped to use side surface screen 52 in FIG. 3 as an extension display for surface screen 24.

Another embodiment of the two-slat, pull-out device is one without any middle folding screens. FIG. 14 illustrates a thin, slab-like two slat device 60 with upper slat 21 having a top surface touchscreen 24 stacked on top of the lower slat 22 attached with rotatable camera module 26 and lens windows 27. Upper slat 21 can be pulled aside and drops down to be flash and flat against lower slat 22, exposing touchscreen 39 on the top surface of slat 22. Touchscreens 24 and 39 are held together tightly with minimal crease. Different means and gadgets may be used to hold slat 21 and slat 22 together in both stacked and parallel positions. Those skilled in the art may use a variety of means and gadgets. As an example, a coil spring tensioner 53 is linked one end to slat 21 and the other end, slat 22 within internal channels or troughs 54 and 55. When slat 21 is stacked on stack 22, coil spring 53 remains in a vertical position to hold slat 21 and slat 22 tightly together. When slat 21 is pulled aside to be parallel with slat 22, coil spring 53 becomes stretched in tension and slides into a horizontal position within the space provided by channel or trough 54 in slat 21 and 55 in slat 22, to lock slat 21 and slat 22 in parallel position. In FIG. 14 one coil spring 53 is shown at the bottom end of device 60. For a balanced tensional force on device 60 body, another coil spring is located on the upper end of device 60 (not shown). Additional sliding tracks or locking magnetic contact buttons may further be applied to stabilize the open device 60.

1. A mobile electronic device comprising:
(a) an upper slat housing having a touchscreen on its top surface
(b) a lower slat housing having a touchscreen on its top surface
(c) a plurality of foldable middle sectional touchscreens in between and connected to the top touchscreens on each slat
(d) a bendable extension touchscreen attached to top surface touchscreen of upper slat on outer side
(e) a depressible edge shield attached to lower slat
(f) a rotatable camera module attached to the lower slat housing.

2. The electronic device of claim 1 wherein the touchscreens are OLED, LCD, AMOLED, micro LED, e-ink paper, or other touch-sensitive display materials and components.

3. The electronic device of claim 2 wherein the middle touchscreen comprises of one single flexible touchscreen divided into sections by a plurality of foldable seam lines.

4. The electronic device of claim 2 wherein the middle touchscreen comprises of a plurality of rigid or semi-rigid sectional touchscreens linked by foldable seam lines.

5. The electronic device of claim 1 wherein the slat housing material is comprised of metal, glass, ceramic, composite laminates, engineered plastic, epoxy composites, wood laminates, and optionally containing additives such as nanoparticles, graphene, or nanocarbon tubes.

6. The electronic device of claim 1 wherein the device body size in closed position has an overall length of about 100 to 180 mm, a width of about 15 to 30 mm, and a height less than 20 mm.

7. The electronic device of claim 1 comprising:
(a) a pivoting rivet connecting upper and lower slats for fan-in and fan-out rotation
(b) a preset and fixed fan-out opening angle of between 90-degree and 180-degree
(c) a plurality of odd-numbered tapered sectional touchscreens linked by foldable seams and supported on backside stiffening ribs connected to said pivoting rivet
(d) a bendable side shield attached to top slat and a wrap-around side screen connected to upper slat surface screen
(e) a rotatable camera module attached to lower slat housing.

8. The electronic device of claim 7 wherein user-defined, different shaped and sized active display areas may be used simultaneously across the entire screen.

9. The electronic device of claim 7 wherein the fan-out rotation is clockwise

10. The electronic device of claim 7 wherein the fan-out rotation is counterclockwise.

11. The electronic device of claim 1 comprising:
(a) a rectangular middle touchscreen having sectional screens linked by foldable seams and connected to the slat top surface touchscreens
(b) stiffening backside support on each said sectional touchscreen
(c) at least one side frame structural support tubing locking the said upper and lower slats in open position while keeping middle screen flat and sturdy
(d) expandable side frame structural supports connecting upper and lower slats in open and closed positions
(e) a rotatable camera module attached to the lower slat.

12. The electronic device of claim 11 wherein the said side frame supports comprise of bistable metals or composite materials.

13. The electronic device of claim 11 wherein the said sectional touchscreens are supported on backside inter-linked stiffening thin foils or strips having foldable seam lines.

14. The electronic device of claim 11 wherein the pull-out direction is towards the right-hand side.

15. The electronic device of claim 11 wherein the pull-out direction is towards the left-hand side.

16. A mobile electronic device comprising:
(a) an upper slat having a touchscreen on its top surface
(b) a lower slat having a touchscreen on its top surface
(c) a rotatable camera module attached to lower slat
(d) a set of internal coil spring tensioners at symmetric locations inside upper slat and lower slat for sliding from stack to parallel position in either direction.

17. The electronic device of claim 1 wherein the power supply battery pack is located in the lower slat housing and other components inside the upper slat housing.

18. The electronic device of claim 1 wherein internal functional components and battery power supply are distributed in both upper and lower slat housing.
